(19) United States
(12) Patent Application Publication
(10) Pub. No.: US 2026/0017078 A1
(43) Pub. Date: Jan. 15, 2026

(54) AUTOMATED VALIDATION OF KUBERNETES INFRASTRUCTURE DESIGN

(71) Applicant: Dell Products L.P., Round Rock, TX (US)

(72) Inventors: Vinay Sawal, Fremont, CA (US); Jason Liu, Wellesley, MA (US); Sithiqu Shahul Hameed, Chennai (IN)

(21) Appl. No.: 18/769,771

(22) Filed: Jul. 11, 2024

(51) Int. Cl. G06F 9/455; H04L 41/12

(52) U.S. Cl. CPC G06F 9/45558; H04L 41/12; G06F 2009/45595

(57) ABSTRACT

Automated infrastructure design validation is disclosed herein. For instance, a topological physical infrastructure wiring diagram is received. Thereafter the topological physical infrastructure wiring diagram is transformed into a multi-graph comprising node equipment representations and unique edge representations. The multi-graph is then used to extract feature data associated with each of the node equipment representations and the unique edge representations, and based on the multi-graph and the feature data a model is trained using a n-level graph neural network. The model, once trained, can be used to evaluate production topological physical infrastructure wiring diagrams.

### BACKGROUND

Kubernetes, sometimes referred to as K8S, is an example of an automation system for deployment, scaling, and management of containerized applications. Architecting a cluster infrastructure for an on-premises or private cloud deployment of such an automation system for containerized applications requires careful planning of the ecosystem, infrastructure and application specific requirements. This includes planning for compute servers for control plane and worker nodes, storage systems, networking equipment for intra-cluster and external communication, network management stack lifecycle management of the nodes, etc.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system that provides validation of Kubernetes infrastructure design, in accordance with various non-limiting example embodiments.

FIG. 2 depicts a method, flow chart, or time sequence, for providing validation for Kubernetes infrastructure design, in accordance with various non-limiting example embodiments.

FIG. 3 illustrates an example multi-graph as used to provide validation of Kubernetes infrastructure design, that implements time based file access, in accordance with various non-limiting example embodiments.

FIG. 4 illustrates an example input wiring schematic for validating a Kubernetes infrastructure design, in accordance with various non-limiting example embodiments.

FIG. 5 illustrates an example computer rack structure that can be used to validate a Kubernetes infrastructure design, in accordance with various non-limiting example embodiments.

FIG. 6 depicts a transition diagram for converting an example input wiring schematic into a multi-graph, in accordance with various non-limiting example embodiments.

FIG. 7 provides an overview illustration of an example system architecture for Kubernetes cluster design validation, in accordance with various non-limiting example embodiments.

FIG. 8 illustrates an example generation of a graph neural network input matrix, in accordance with various non-limiting example embodiments.

FIG. 9 depicts an example final normalized Adjacency Matrix, in accordance with various non-limiting example embodiments.

FIGS. 10A and 10B illustrate an example graph neural network feature matrix generation, in accordance with various non-limiting example embodiments.

FIG. 11 illustrates an example embodiment relating to graph neural network training and testing of a model, in accordance with various non-limiting example embodiments.

FIG. 12 illustrates that, once the model is deployed, new wiring schematic diagrams can be fed to the trained graph neural network model for predicting a score, in accordance with one or more example embodiments.

FIG. 13 illustrates an elastic cloud storage (ECS) system, in accordance with various non-limiting example embodiments.

FIG. 14 illustrates a block diagram representing an illustrative non-limiting computing system or operating environment in which one or more aspects of various non-limiting embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

At the outset it should be observed that while the description set forth herein is explicated in terms of providing automated validation of Kubernetes infrastructure design, the described subject matter is not so limited. The subject disclosure can have general applicability in the validation of other infrastructure designs, for instance: cloud storage equipment infrastructure designs, wireless cellular network infrastructure equipment designs, software as a service (SaaS) infrastructure designs, platform as a service (PaaS) infrastructure designs, cloud processor environment architecture designs, and the like.

As mentioned, Kubernetes is an example of an automation system for deployment, scaling, and management of containerized applications, and careful planning of the ecosystem, infrastructure and application specific requirements are implicated when architecting a cluster infrastructure, whether for an on-premises and/or private cloud deployment of such an automation system for containerized applications. This planning includes planning for compute servers for control plane and worker nodes, storage systems, networking equipment for intra-cluster and external communication, network management stack lifecycle management of the nodes, etc.

For instance, when designing the physical aspects of a Kubernetes cluster, several potential problems can arise relating to hardware selection, network configuration, storage, scalability, and security. Verification of these components to ensure adherence to best practices leads to producing a robust and efficient cluster, and is thus desirable. Conventionally, this has been attempted with error prone and time consuming manual inspection/verification of a topology diagram. However, here are just a few of some common problems and considerations, with respect to hardware selection and placement, and network complexity and performance, which make conventional practices unwieldy and ill-suited.

For instance, with respect to hardware selection and placement, example issues include underestimating the central processing unit (CPU), memory, and storage needs of applications that will be in execution of the selected hardware and the placement of the identified can lead to performance bottlenecks. Single points of failure in hardware components (e.g., using a single physical server for master node in an on-premises setup). Using inadequate hardware equipment (e.g., using a low power server for worker nodes and high-power server for master node).

With respect to network complexity and performance, example issues can include considerations such as: (i) high-performance applications generally require high-bandwidth networking hardware and configurations; inadequate network infrastructure therefore can become a bottleneck, affecting pod-to-pod and ingress/egress traffic; (ii) ensuring network security without introducing unnecessary complexity can be challenging; network security misconfiguration can expose the cluster to vulnerabilities or block legitimate traffic; (iii) Kubernetes often uses overlay networks to enable pod communication across nodes. Selection of appropriate network equipment with necessary functionality is to be done with precision in the design process; (iv) service discovery, load-balancing, namespace isolation can also complicate the design of the infrastructure.

In regard to the storage challenges, illustrative instances can include managing persistent storage for stateful applications (e.g., applications that save client data from the activities of a first session for use in subsequent sessions; stateful applications require persistent storage and often rely on databases, file systems, or other forms of data persistence to maintain state across different instances of an application in execution; execution of stateful applications on Kubernetes, for example, can involve special considerations to ensure data consistency and availability). In this context, since Kubernetes stateful applications can be complex, especially in on-premises environments, considerations can include choosing between local and network storage, dynamic provisioning, and storage class requirements. Additionally, storage performance can vary widely, affecting application responsiveness and reliability. Accordingly, ensuring high input/output operations per second (IOPS) (e.g., a performance metric generally used to characterize the speed at which storage devices can read and write data), and low latency can be essential for databases and other I/O-intensive applications.

Concerning environmental factors such as the fact that high-density processing equipment clusters can consume significant power and generate a lot of heat; adequate cooling and power supply can be essential, especially in on-premises data centers. Additionally, physical space constraints can also limit the expansion of on-premises clusters; efficient use of rack space and planning for future expansion can also be important considerations.

Other issues that need to be taken into account can include: (a) inappropriate compute server selection for Kubernetes' control/data plane, (b) incorrect network switch selection, wherein there is, for example, no support for the implementation of network virtualization technologies, such as virtual extensible local area network (VxLAN) protocols that can enable the creation of logical Layer 2 networks over a Layer 3 (IP) network infrastructure for intra-cluster communication, (c) inadequate bandwidth for north-south application workload traffic, east-west data workload traffic, (d) incorrect wiring of the cluster management network, and (e) availability of necessary hardware equipment due to supply chain issues.

In the face of the foregoing issues, it would be beneficial to have an automatic analysis tool for the design and/or adaptation of hardware and software infrastructures that can eliminate and/or mitigate most design level issues in the context, for example, of containerized applications, such as Kubernetes, prior to deployment.

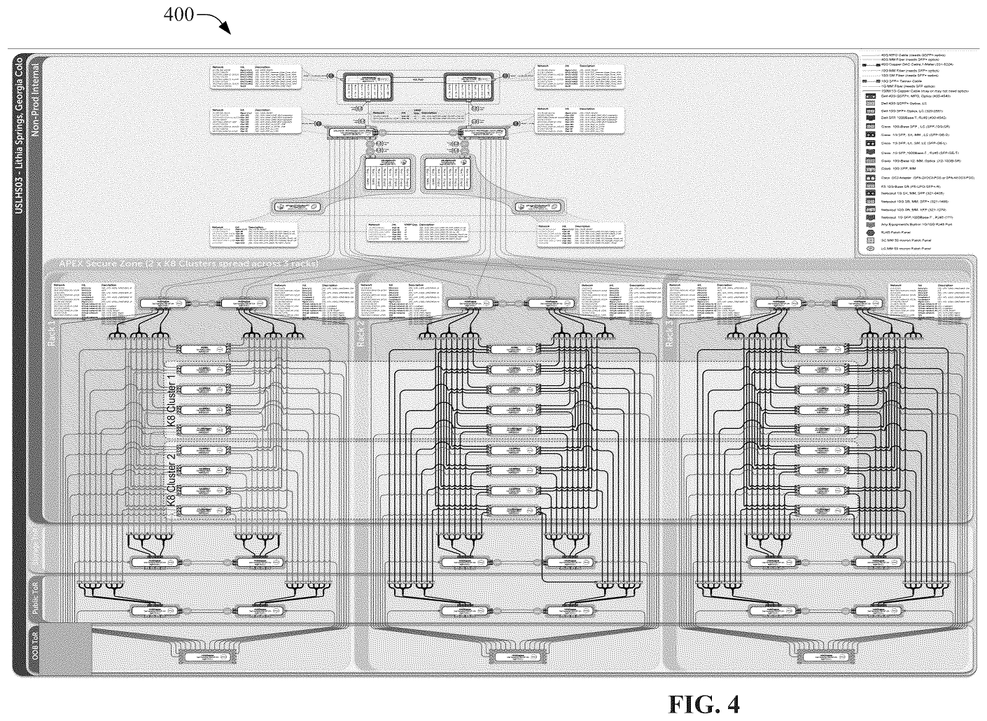

To address these and/or other deficiencies with the state of the art, a validation engine can be deployed that is able to validate the robustness of infrastructure architecture, such as a Kubernetes infrastructure architecture, by modeling the problem as a Graph Classification problem using a Supervised Deep-learning based Graph Neural Network (GNN) technique. In some example embodiments, input to the validation engine can be a physical infrastructure topology design wiring diagram, input as a standard schematic wiring diagram that illustrates each and every equipment comprising the Kubernetes topology design, as well as any and all wiring interconnections between one or more of the equipment included in the topology design. In additional and/or alternative sample embodiments, the physical infrastructure topology design wiring diagram (see e.g., FIG. 4 for an example standard schematic wiring diagram) can be reduced to an open standard file format and data interchange format representation of the topology design, a file format that can use human-readable text to store and transmit data objects consisting of attribute-value pairs and/or arrays (or other serializable values that can be used to translate a data structure or object state into a format that can be stored and/or transmitted, and subsequently reconstructed), such as javascript object notation (JSON) files, wherein the JSON files can be input to the verification engine. As an example implementation, the analysis by the validation engine ultimately generates and outputs a real-value score (0.0≤score≤1.0) that can represent the strength/weakness of the input topological design, such that the higher the real-value score the better the design.

The disclosed systems and methods, in accordance with various embodiments, provide a system, apparatus, or device comprising: a processor; and a memory that stores executable instructions that, when executed by the processor, facilitate performance of operations. The operations can comprise: receiving a first representation of a first physical infrastructure topology wiring diagram, transforming the first representation of the first physical infrastructure topology wiring diagram into a multi-graph comprising a group of nodes and a collection of unique edges, based on the multi-graph, performing a first feature extraction process on the group of nodes and a second feature extraction process on the collection of unique edges; and based on a first result of the first feature extraction process and a second result of the second feature extraction process, training a model using a n-level graph neural network, wherein n represents an integer value greater than, or equal to, 3, the training comprising training the model to be usable to evaluate a second representation of a second physical infrastructure topology wiring diagram based on the model.

Concerning the foregoing, the first representation of the first physical infrastructure topology wiring diagram can be received as a wiring schematic comprising a group of hardware equipment representations representative of hardware equipment and a group of wiring representations representative of interconnections between the hardware equipment in the group of hardware equipment representations. Additionally and/or alternatively the first representation of the first physical infrastructure topology wiring diagram can be received as an open standard data interchange file format representation of the first physical infrastructure topology wiring diagram, wherein physical interconnections between first hardware equipment included in a group of hardware equipment and second hardware equipment included in the group of hardware equipment are represented as attribute-value pairs.

Further, in some embodiments the group of nodes can be representative of firewall equipment, global traffic management equipment, local traffic management equipment, load balancing equipment, master node equipment, and worker node equipment. In other embodiments the group of nodes can be representative of management resource equipment, storage resource equipment, peer-to-peer network equipment, wherein at least the management resource equipment and the storage resource equipment enables resource sharing amongst first hardware equipment included in the group of equipment and second hardware equipment included in the group of equipment.

In many embodiments a unique edge of the collection of unique edges can comprise a wired interconnection between first hardware equipment included in a group of hardware equipment and second hardware equipment included in the group of hardware equipment. In additional embodiments the collection of unique edges can comprise a wireless interconnection between first hardware equipment included in a group of hardware equipment and second hardware equipment included in the group of hardware equipment.

Additional operations in some embodiments the performing of the first feature extraction process, based at least in part on the first physical infrastructure topology wiring diagram can further comprise extracting a group of attribute properties associated with first hardware equipment included in a group of hardware equipment, and wherein an attribute of the group of attribute properties can be a performance metric that characterizes a speed at which storage equipment is able to read and write data.

In accordance with further embodiments, the subject disclosure describes a method, comprising a sequence of acts that can include: in response to receiving a first representation of a first physical infrastructure topology wiring diagram, transforming, by a device comprising at least one processor, the first representation of the first physical infrastructure topology wiring diagram into a multi-graph comprising a group of nodes and a collection of unique edges, based on the multi-graph, performing, by the device, a first feature extraction process on the group of nodes to generate a first result and a second feature extraction process on the collection of unique edges to generate a second result; and evaluating, by the device, a second representation of a second physical infrastructure topology wiring diagram based on a model that was trained based on the first result and the second result using a n-level graph neural network, wherein n represents an integer value greater than 2.

In some embodiments the first representation of the first physical infrastructure topology wiring diagram can be received as a wiring schematic comprising a group of hardware equipment representations representative of hardware equipment and a group of wiring representations representative of interconnections between the hardware equipment in the group of hardware equipment representations. In additional and/or alternative embodiments, the first representation of the first physical infrastructure topology wiring diagram can be received as an open standard data interchange file format representation of the first physical infrastructure topology wiring diagram, wherein physical interconnections between first hardware equipment included in a group of hardware equipment and second hardware equipment included in the group of hardware equipment are represented as attribute-value pairs.

In further embodiments the group of nodes can be representative of firewall equipment, global traffic management equipment, local traffic management equipment, load balancing equipment, master node equipment, and worker node equipment. In similar embodiments the group of nodes can be representative of management resource equipment, storage resource equipment, peer-to-peer network equipment, wherein at least the management resource equipment and the storage resource equipment enables resource sharing amongst first hardware equipment included in the group of equipment and second hardware equipment included in the group of equipment.

In other embodiments a unique edge of the collection of unique edges can comprise a wired interconnection between first hardware equipment included in a group of hardware equipment and second hardware equipment included in the group of hardware equipment. In additional other embodiments the collection of unique edges can comprise a wireless interconnection between first hardware equipment included in a group of hardware equipment and second hardware equipment included in the group of hardware equipment.

Additionally and/or alternative acts can include based at least in part on the first physical infrastructure topology wiring diagram, extracting, by the device, a group of attribute properties associated with first hardware equipment included in a group of hardware equipment, wherein an attribute of the group of attribute properties is a performance metric that characterizes respective speeds at which storage equipment reads and writes data.

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can comprise: receiving a first representation of a first physical infrastructure topology wiring diagram, transforming the first representation of the first physical infrastructure topology wiring diagram into a multi-graph comprising a group of nodes and a collection of unique edges, based on the multi-graph, performing a first feature extraction process on the group of nodes and a second feature extraction process on the collection of unique edges, based on a first result of the first feature extraction process and a second result of the feature extraction process, generating a model using a n-level graph neural network, wherein n represents an integer value greater than, or equal to, a defined value, and evaluating a second representation of a second physical infrastructure topology wiring diagram based on the model.

In regard to the foregoing the evaluating of the second representation of the second physical infrastructure topology wiring diagram can comprise: generating a real number score value based on the model, comparing the real number score value with a threshold value, and determining, based on the real number score value exceeding the threshold value, that the second representation of the second physical infrastructure topology wiring diagram is a good design. Additionally and/or alternatively the evaluating of the second representation of the second physical infrastructure topology wiring diagram can comprise: generating a real number score value based on the model, comparing the real number score value with a threshold value, and determining, based on the real number score value falling below the threshold value, that the second representation of the second physical infrastructure topology wiring diagram is a poor design.

An additional operation that can be performed in accordance with various described embodiments can comprise based on the real number score value, regenerating the model using the n-level graph neural network.

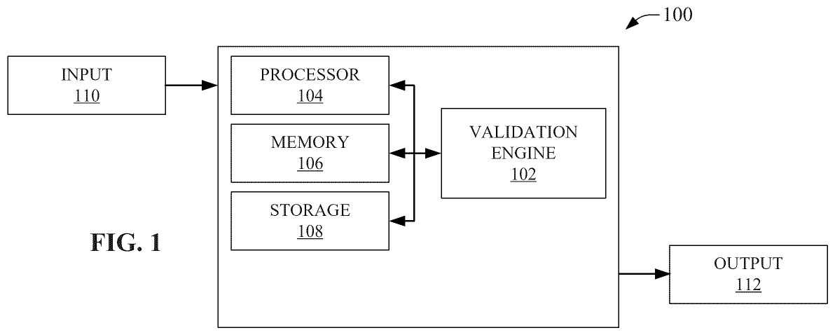

With reference to FIG. 1 that depicts a system 100 that provides validation of Kubernetes infrastructure design, in accordance with various non-limiting example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IoT) equipment, multimedia players, and the like.

System 100 can comprise validation engine 102 that can be in operative communication with processor 104, memory 106, and storage 108. Validation engine 102 can be in communication with processor 104 for facilitating operation of computer-executable instructions or machine-executable instructions and/or components by validation engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by validation engine 102 to produce one or more useful, concrete, and tangible result, and/or transform one or more articles to different states or things. Further, system 100 can also generate and output the useful, concrete, and tangible result and/or the transformed one or more articles as output 112.

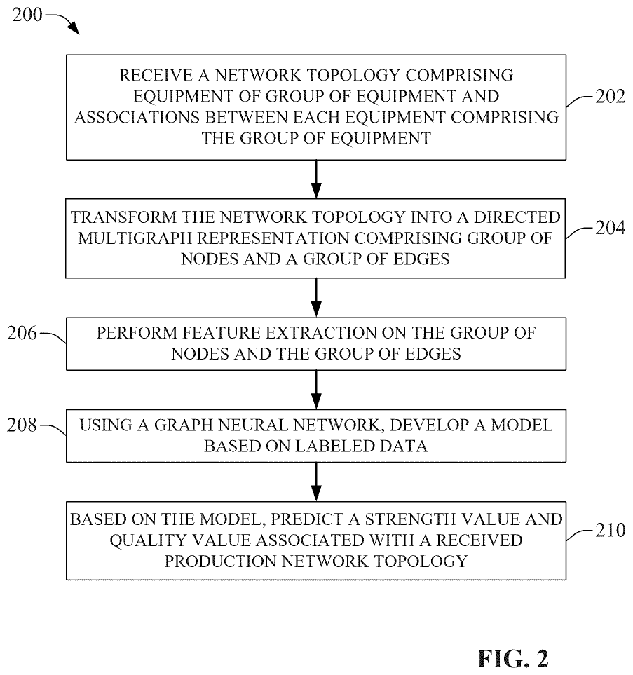

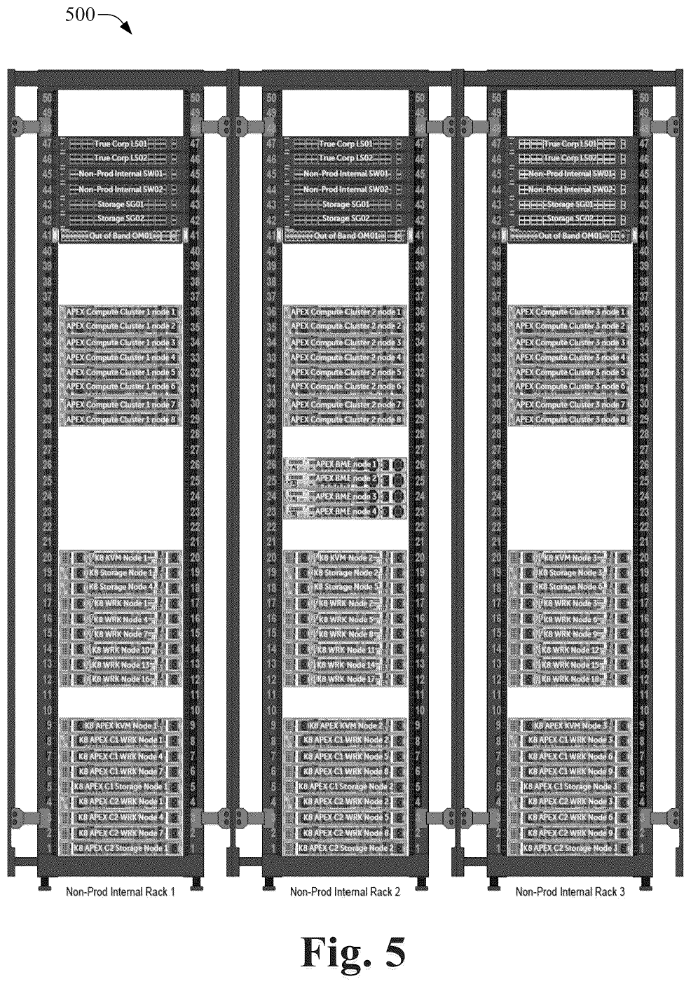

Now in reference to FIG. 2 that illustrates a method 200 that provides acts that can be used to perform validation of Kubernetes infrastructure design, in accordance with various non-limiting example embodiments. Method 200 can commence at act 202 where validation engine 102 can receive, as input 110, a representation of a physical infrastructure topology design wiring diagram. As noted earlier, the representation of the physical infrastructure topology wiring diagram can be input as a wiring schematic. In most instances, a wiring schematic can comprise a wiring layout regarding how physical hardware equipment such as network infrastructure equipment, processing equipment, storage equipment, and the like are communicatively interconnected with one another via wired and/or wireless communication mediums (e.g., copper cabling, fiber optic cabling, . . . ). As will be appreciated by those of ordinary skill, for purposes of Kubernetes implementations the majority of the equipment typically can be situated within one or more racks (see FIG. 5) within one or more customized facility, such as a datacenter. As has also been noted above, validation engine 102, in alternative and/or additional embodiments, can also receive input 110 of the representation of a physical infrastructure topology design wiring diagram as one or more JSON file.

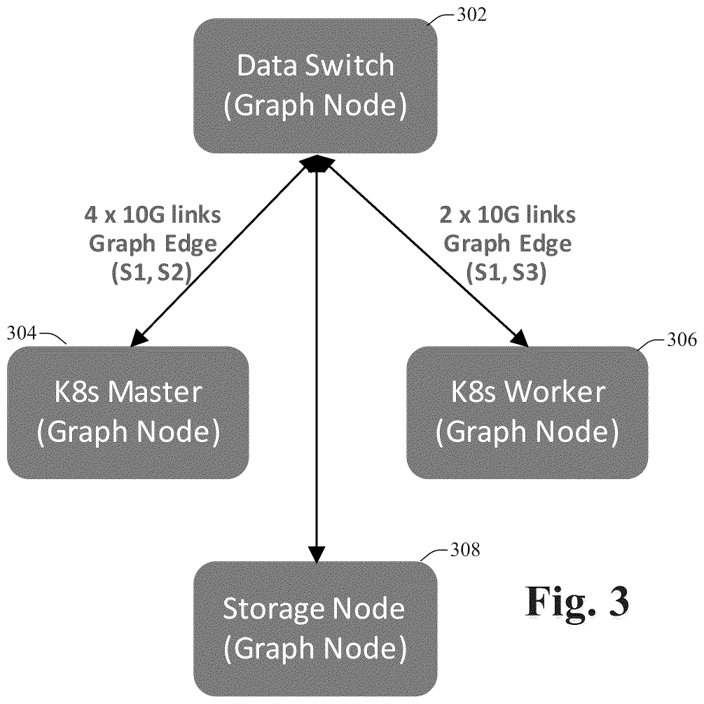

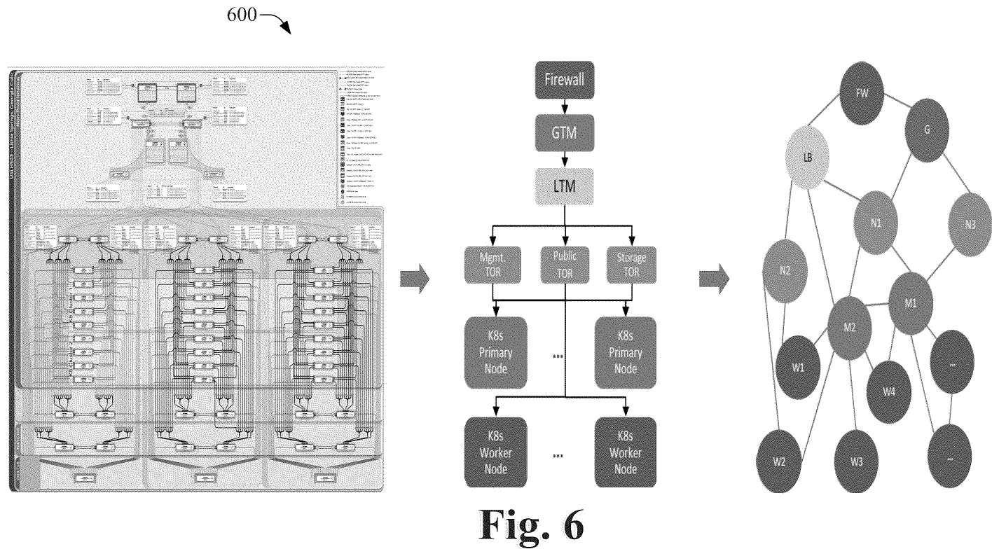

Validation engine 102, at act 204, and as depicted in FIG. 6, in response to receiving input 110 can transform a representation of a physical infrastructure topology design wiring diagram 602 into a directed multi-graph comprising a group of nodes and a collection of associated unique identity edges 606. As illustrated in FIG. 3 the directed multi-graph 300 comprises nodes and unique identity edges, wherein every element in the infrastructure topology, input at act 202, can be considered a graph node (e.g., data switch graph node 302, K8s master graph node 304, K8s worker graph node 306, and storage graph node 308) associated with the respective characteristics and capabilities as attributes of the graph nodes. Typical elements included in an infrastructure topology can include equipment such as: firewall equipment, global traffic management (GTM) equipment, local traffic management (LTM) equipment, load balancing equipment. equipment that implements and enables the distribution and sharing of resources, such as management resources, storage resources, and the like using peer-to-peer (P2P) networking technologies, and the aforementioned K8 master node equipment (e.g., K8s master graph nodes 304), and/or K8 worker node equipment (e.g., K8s worker graph node 306).

As illustrated in FIG. 3 the directed arrows (e.g., edges) interconnect the various graph nodes (e.g., data switch graph node 302, K8s master graph node 304, K8s worker graph node 306, and storage graph node 308) and can represent communication connections between the various equipment. For instance, as illustrated in FIG. 3 there can be 4×10 Gigabits per second (Gbps) communication links between equipment represented as a data switch graph node 302 and equipment represented as a K8s master graph node 304. Similarly, there can be 2×10 Gbps communication links between equipment represented as a data switch graph node 302 and the equipment represented as K8s worker graph node 306. There can be multiple edges (e.g., communication connection links) with unique attributes between respective nodes.

Returning back to FIGS. 1 and 2, at acts 206 and 208, based on the directed multi-graph developed at act 204, validation engine 102 can perform feature extraction on the group of nodes and their respective and associated edges at act 206, and thereafter, at act 208, validation engine 102 can use a GNN to train a model based on labeled data that can be, or can have been, generated with organic methods and/or synthetic methods, making training of the model a supervised learning method.

With regard to training the model, at act 208, based on labeled data generated with organic methods, this can, in some embodiments, involve validation engine 102 utilizing natural data sources and more intuitive, human-like approaches to data preparation and model training, leveraging techniques such as data augmentation, natural data collection, semi-supervised learning, and iterative improvement based on feedback data. Typically, generating labeled data using organic methods can comprise: (i) gather data from natural sources, such as online repositories or user uploads; (ii) clean, normalize, and augment the data; (iii) select/determine an appropriate convolutional neural network (CNN) architecture, train the neural network on the preprocessed data, and evaluate its performance; (iv) use semi-supervised learning and iterative feedback to refine the model; and (v) deploy the model, monitor its performance, and retrain as necessary.

Concerning training the model, at act 208, based on synthetic methods, this can, in additional and/or alternative embodiments, involve validation engine 102 generating artificial data to augment or replace real-world data. This approach can be particularly useful when real data is scarce, expensive to collect, or contains privacy concerns. Synthetic data can be generated using various techniques such as simulations, generative adversarial networks (GANs), data augmentation, and synthetic data platforms. Typical acts that can be performed by validation engine 102 in generating labeled data using synthetic methods can comprise: (i) using GANs or simulations to create synthetic data; (ii) clean, normalize, and augment the synthetic data; (iii) select/determine an appropriate CNN architecture, train the model using the synthetic data, and then evaluate the model's performance; (iv) fine-tune the model with a small set of real data; and (v) deploy the trained model, monitor the trained model's performance, and retrain the deployed model as necessary.

At act 210 validation engine 102 can use the trained model to predict a strength value or weakness value and predict a quality value associated with a received production (unknown) version of an input (e.g., via input 110) physical infrastructure topology wiring diagram. The predicted strength values and/or weakness values, and/or the quality values associated with the input production version of the physical infrastructure topology wiring diagram can be output by validation engine 102 (system 100) as output 112.

It should be observed in regard to the foregoing methodology 200, that validation engine 102 can receive feedback data comprising the predicted strength values and/or the predicted weakness values as well as the predicted quality values. This feedback data, if needed, can then be used to better refine the developed model, particularly when one or more of the predicted strength values and/or predicted weakness values, and/or the predicted quality values exceed and/or fall below respective defined threshold values.

FIG. 6 shows the transformation of a representation of a physical infrastructure topology 602 (e.g., a representation of a physical infrastructure equipment topology comprising a plurality of devices/equipment) into a multi-graph representation 606 of the physical infrastructure topology. As illustrated in FIG. 6, there can be an intermediate act where the representation of the physical infrastructure topology 602 is initially transformed into a logical and hierarchical representation where the equipment included in the physical infrastructure equipment topology are categorized based on the purpose served by the equipment, such as firewall equipment, GTM equipment, LTM equipment, load balancing equipment, equipment that implements and enables the distribution and sharing of resources, such as management resources, storage resources, and the like using peer-to-peer (P2P) networking technologies, and the aforementioned K8 master node equipment (e.g., depicted in FIG. 3 as K8s master graph nodes 304), and/or K8 worker node equipment (e.g., depicted in FIG. 3 as K8s worker graph nodes 306).

In regard to the multi-graph representation 606, the node denoted as “FW” can be a representation of firewall equipment, the node denoted as “GTM” can represent GTM equipment, the node depicted as “LTM” can represent LTM equipment, and the nodes “N1,” “N2,” and “N3” can be representative of equipment that implements and enables the distribution and sharing of resources, such as management resources, storage resources, and the like using peer-to-peer (P2P) networking technologies (e.g., BitTorrent an open source facility/functionality that decentralizes distribution and leverages peer-to-peer networks for the efficient data transfer and distribution of large files and other content that can be legally shared). Further concerning the multi-graph representation 606, the nodes “M1” and “M2” can represent groups of K8 master node equipment, and the nodes “W1,” “W2,” “W3,” “W4,” and “ . . . ” can be representative of collections of K8 worker node equipment.

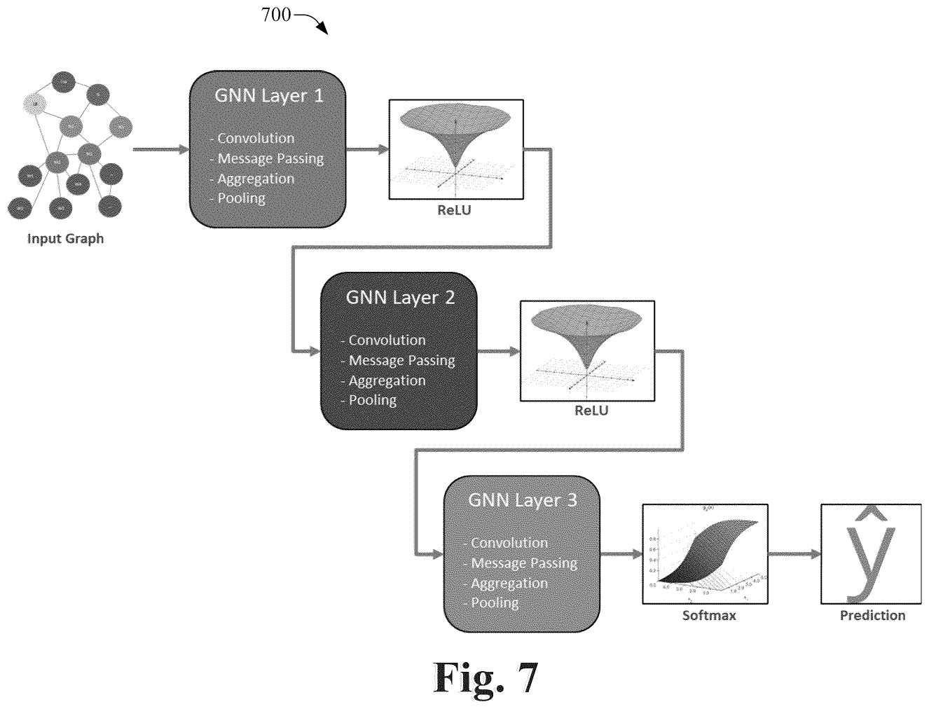

In regard to FIG. 7, this illustration depicts an example system architecture 700 for a 3-layer graph neural network (GNN) model in accordance with various example embodiments. In implementation verification engine 102, at each respective layer of the 3-layer GNN model, can perform functions comprising, at least, convolutions using filters, message passing to other nodes, aggregation of messages, and/or pooling.

Thus, at the first layer of the 3-layer GNN model (e.g., GNN layer 1), and in response to receiving a multi-graph (e.g., multi-graph 606), the first layer of the 3-layer GNN model can perform a first convolution by applying a first filter to multi-graph 606. Performance, by verification engine 102, of the first convolution through application of the first filter to the multi-graph 606 can produce a first feature map. Simultaneously with, and/or subsequent to, verification engine 102 performing the first convolution by applying the first filter to the multi-graph 606, verification engine 102 can also implement message passing, wherein the nodes comprising the multi-graph exchange information with neighboring nodes to learn representations of the multi-graph structure and node features. Message passing typically involves three main steps: message generation (e.g., generate messages to be sent to neighboring nodes based on a node's current state and the states of each of the neighboring nodes), message aggregation (e.g., each node collects incoming messages from each of its neighboring nodes, and/or node update (e.g., each node updates its state based on the aggregated messages received from each neighboring node). In near contemporaneity with, or shortly thereafter having implemented message passing, verification engine 102 can implement pooling, wherein methods can be used to reduce the size of the graph, typically by combining or summarizing nodes, while preserving essential structural and feature information. Example methods that can be implemented, by verification engine 102, to effectuate pooling can include: (I) performing node-level pooling (e.g., (i) determine a maximum feature value among the nodes' neighbors; (ii) determine an average of the feature values of the nodes' neighbors; and (iii) sum the feature values of the nodes' neighbors); (II) performing graph level pooling (e.g., aggregating node features across the entire multi-graph to create a fixed-size representation by (a) determining the maximum value of each feature across all nodes; (b) determining the average value of each feature across all nodes; and (c) summing the feature values of all nodes); and/or (III) performing hierarchical pooling wherein: (i) a clustering process can be used to coarsen the multi-graph by merging nodes into super-nodes; (ii) a learnable assignment matrix can be used to map nodes to clusters, providing a soft clustering of nodes; and (iii) noting that k represents an integer value, determining the top k nodes based on a determined score value, retaining important nodes while reducing the size of the multi-graph. The output from the first GNN layer then can be directed to a first activation function, such as a Rectified Linear Unit (ReLU), which can aid in introducing non-linearity, which can be essential for learning complex patterns in graph-structured data. Further, the scarcity introduced by ReLU can also be beneficial in handling large and sparse graphs typically encountered in GNN applications.

Once processing associated with the first layer of the 3-layer GNN model has been completed, and the first activation function applied, the result associated with the first layer of the 3-layer GNN model can be directed to a second layer of the 3-layer GNN model. The actions performed by validation engine 102 in the context of the second layer of the 3-layer GNN model can be similar to those detailed in connection with the first layer of the 3-layer GNN model. Thus, at the second layer of the 3-layer GNN model a second convolution can be performed by verification engine 102, wherein a second filter can be applied to results fed forward from the implementation of the first layer. Thereafter, as observed above, message passing as outlined earlier can be performed. Further pooling can be facilitated to reduce the size of graph. Additionally, as also noted above, the results of the implementation of the second layer of the 3-layer GNN model can be conveyed to a second ReLU, for example.

On completion of processing of the second layer of the 3-layer GNN model, processing by the third layer of the 3-layer GNN model can involve similar acts as enunciated above in connection with the first and second layers of the 3-layer GNN model. Once verification engine 102 has completed the actions associated with the third layer of the 3-layer GNN model, an activation function, such as the softmax activation function that is generally used in the output layer of classification neural networks such as GNNs, can be applied. This activation function can transform vectors of raw scores into probabilities, making it suitable for multi-class classification problems. The output, for example, of the softmax activation function, can provide a predication of the overall strength and/or the overall weakness of the input multi-graph (e.g. multi-graph 606) as a distribution of probability values.

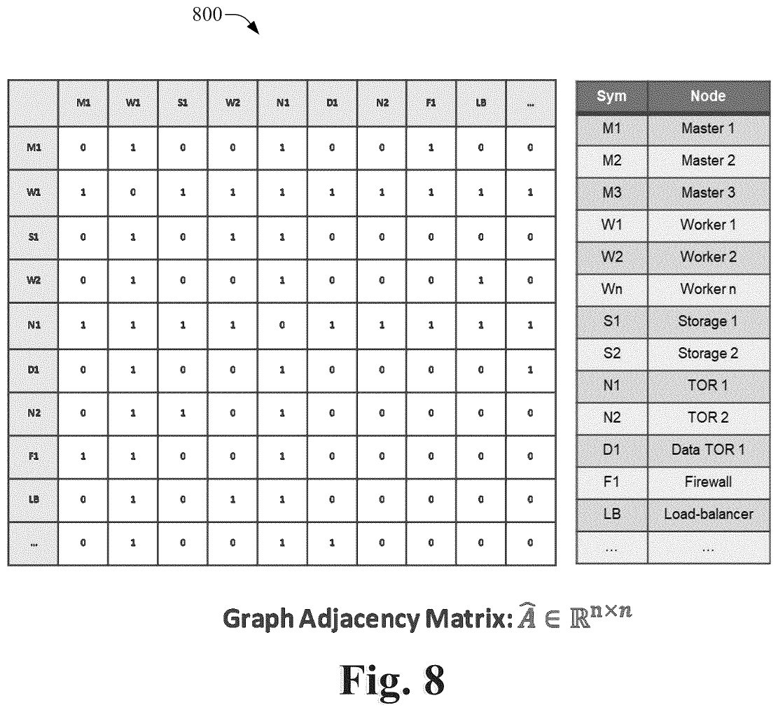

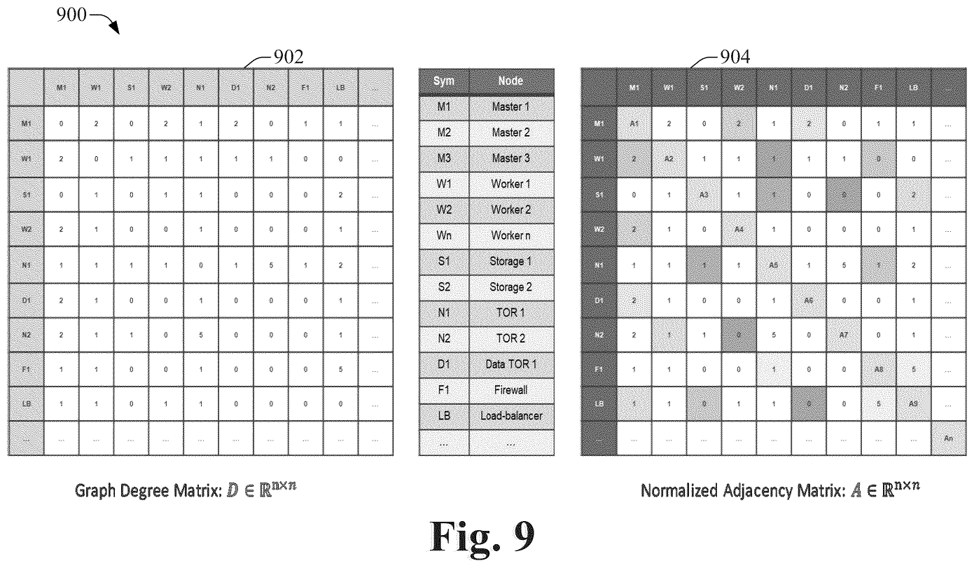

Turning now to FIGS. 8 and 9, that illustrates an example generation of a GNN input matrix 800 and 900, in accordance with various example embodiments. The GNN input matrix 800 can be generated by (i) converting a wiring diagram (e.g., wiring diagram 400) into a multi-graph (e.g., multi-graph 606); (ii) create an adjacency matrix Â (Ā∈ [symbol] ^{n×n}) 800 to represent the multi-graph, wherein the adjacency matrix Â (Â∈ [symbol] ^{n×n}) 800 is an n×n matrix. where n represents the number of nodes included in the multi-graph; (iii) augment the adjacency matrix with edge features such as link type, link speed, number of links connected between two nodes, etc.; (iv) create a graph degree matrix D (D∈ [symbol] ^{n×n}) 902 that can represent degree of each node in the multi-graph. The degree matrix 902 can be an n×n Identity matrix; (v) normalize Â with D to build the GNN input Matrix A using the following formula:

$$A = {D}^{- \frac{1}{2}} \cdot \hat{A} \cdot {D}^{- \frac{1}{2}} ;$$

and (vi) finalize the normalized adjacency matrix as depicted as 904.

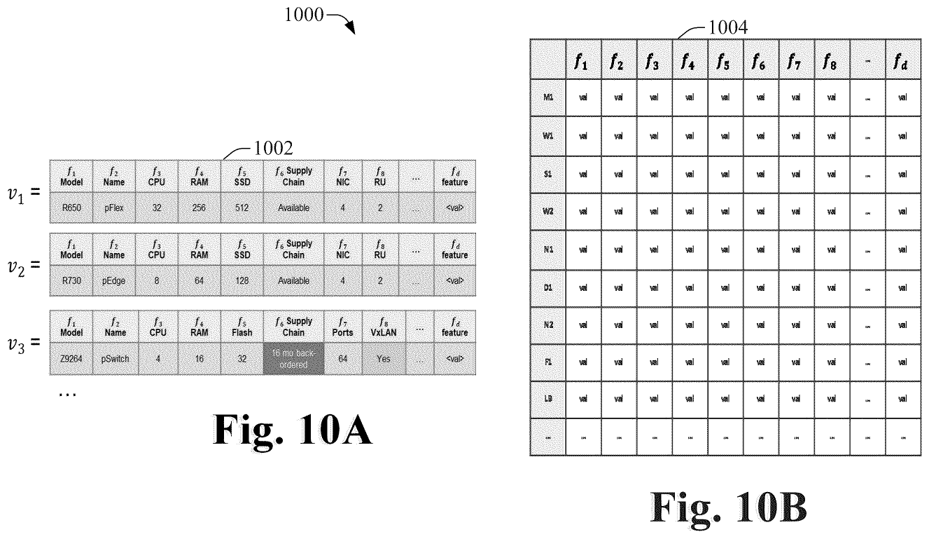

In reference to FIG. 10 that provides illustration of an example generation of a GNN input matrix 10A and 10B, in accordance with various example embodiments. As shown in FIG. 10A, for every node in an input multi-graph (e.g., multi-graph 606), extract features fⱼ to create a feature vector vᵢ (vᵢ ∈ [symbol] ^{1×d}). Dimension d of feature vector vᵢ can be the number of features used. The same number of features can be used for all nodes. Further, the node features such as equipment/device model, processor type, number of processor cores, random access memory (RAM) sizes, supply chain availability (e.g., the ease/difficulty of obtaining the physical hardware equipment, acquiring software to be operational on the equipment/devices, and/or obtaining appropriate export hardware/software licenses, licenses to facilitate legal execution of the software on the hardware, desired feature support, etc. Any unique attribute associated with respective nodes can be used as feature.

Next, categorical (nominal, ordinal) features can be converted into numeric value features using label encoders and one-hot vector encoders. Label encoders convert categorical data into numerical value data that models can process. The label encoders assign a unique integer to each category. One-hot vector encoders provide the facility to represent categorical data as groups of binary vectors, wherein each vector has a length equal to the number of unique categories, with a single element set to 1 (representing the presence of that category) and all other elements set to 0. Thereafter, as depicted in FIG. 10B, all feature vectors can be stacked to create a feature matrix X that represents all features from all nodes: X∈ [symbol] ^{n×d}.

With respect to GNN Layers, convolutions and prediction, the following example process provides that feature vectors can be stacked to create a feature matrix X (e.g., feature matrix 1004) that can be representative all features from all nodes: X∈ [symbol] ^{n×d} Next, feature Matrix X (e.g., feature matrix 1004B) and multi-graph adjacency matrix A(e.g., adjacency matrix 904) can be fed to the GNN layers for processing. GNNs are generally similar to CNNs, except that GNNs can preserve the graph structure without steam-rolling the input data. GNNs generally utilize the concept of convolutions on graph by aggregating local neighborhood regional information using multiple filters/kernels to extract high level representations in a graph. For purposes of this disclosure, the convolution filters used for the GNN are inspired by digital signal processing and graph signal processing, and can be categorized in the time dimension and/or the space dimension. Spatial filters generally combine neighborhood sampling with values based on connectivity (e.g., degree of connectivity k, where k is representative of a natural number value/integer value). Typically, spectral filters are used in image processing and computer vision to manipulate or analyze the spatial frequency content of images in order to provide smoothing, sharpening, edge detection, and noise reduction in relation to input images. There are various types of special filter, such as linear filters and non-linear filters.

Linear filters can include smoothing filters (e.g., mean filters that average values within a neighborhood in order to reduce noise; Gaussian filters that can weight values using Gaussian functions to achieve smoothing effects; sharpening filters such as Laplacian filters that can emphasize regions of rapid intensity change and can be used for edge detection, and unsharp masking filters that can enhance edges by subtracting a smoothed version of the image from the original image). Non-linear filters can include filters such as median filters that generally replace each pixel with the median of the pixel values in the neighborhood. Spectral filters can use, for example, Fourier transforms and Eigen decompositions to aggregate node information.

Feature Matrix X (e.g., feature matrix 1004B) can then be fed as an input to the GNN: H^{[0]}=X, wherein GNN layers can perform convolutions (e.g., sliding filters across the input data and performing element-wise multiplication and/or summation on the input using predefined filters) to generate an output with a dimension that can be different from that of the input: H^{[1]}=σ(A·H^{[0]}·W^{[0]}+b^{[0]}). After flowing through multiple layers with different convolution filters, the hidden layer output of last layer can be fed to a softmax non-linear function, for instance, that can produce a probability distribution of possible score values summing to 1. This can be the predicted score: ŷ=softmax(H^{[l]}).

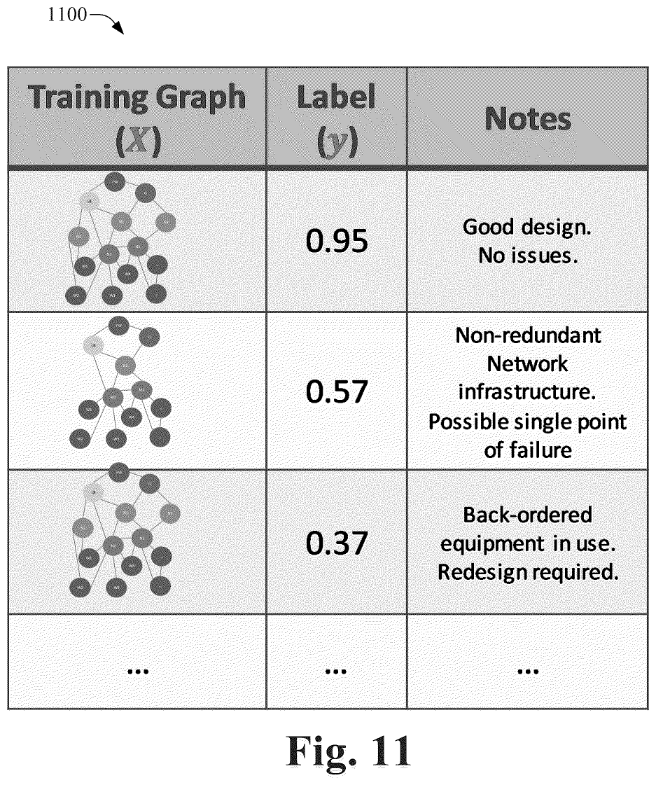

In regard to GNN training and testing, to train and test the developed model, as shown in FIG. 11, existing network topology designs (e.g., 400) can be collected and used to generate a data-set of graphs using permutations of commonly used topologies in current customer infrastructure deployments. Thus, for example, every data point in the data-set can be a tuple (X, y), wherein X represents an input wiring-diagram multi-graph, and y can be representative of a score associated with the input wiring diagram multi-graph. In this regard, a variety of node values and link values can be used for generating the multi-graphs. Non-limiting examples include: (i) node types, such as server equipment, storage equipment, networking equipment, firewall equipment, load balancing equipment; (ii) graph size (e.g., permutations of various node types); (iii) link bandwidths (e.g., 1 Gbps, 10 Gbps, 40 Gbps) between nodes; and (iv) number of links between nodes (e.g., 1, 4, 8). The data can be uniformly distributed with an approximately equal number of good and bad topologies.

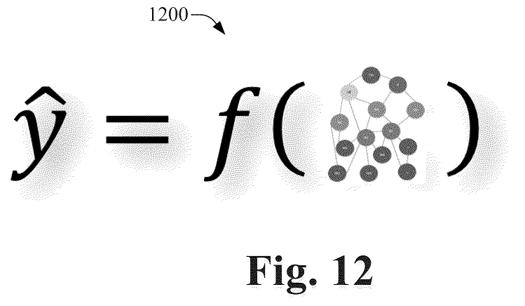

With respect to deployment of a cluster infrastructure design validation for an automated system for containerized applications, such as Kubernetes, once the model is deployed, new topology diagrams can be fed to the trained GNN model for predicting the score, as shown by FIG. 12. The analysis process can generate a real-valued score (0.0≤ŷ≤1.0) that can be representative of the strength of the network topology design, such that the higher the score, the better the network topology design.

Using a qualitative policy based on business requirements, thresholds can be defined to quantify the generated score. Any score above a defined first threshold can be considered a good design, for example, a score above a first defined threshold value (tₕ≤ŷ≤1.0) can be considered a “green” good design. A score in between the first defined threshold and a second defined threshold value (tₗ≤ŷ≤tₕ) can be considered a “yellow” middling/adequate design. A score below a third defined threshold value (0.0≤ŷ≤tₗ) can be considered a “red”. invalid design.

For remediation, depending on the requirements, suitable actions can be taken upon receiving a bad score (e.g., a “yellow” middling/adequate design and/or a “red”. invalid design).

A clear benefit of one or more benefits of the subject embodiments is the provision of a GNN based technique to automatically validate strength/robustness of a topology design of an automated system for containerized applications (e.g., Kubernetes) prior to deployment with an ability to incorporate logistical features, such as supply chain constraints of desired equipment in the determination of the robustness. In this regard, one or more of the subject embodiments also are faster and more efficient than any rule-based method since there could be millions of permutations in a multi-graph topology diagram that the rule-based method must exhaust.

Further, as noted with respect to the conventional manual approach, given the complexity and the number of people involved in the process, the possibility for human error in either the design or in failing to appreciate a design-related issue is very high. The subject embodiments for the automatic topology analysis solution enables identification of the issues well prior to deployment.

The proposed solution enables elimination/mitigation of logistical challenges such as supply-chain constraints on equipment being procured for an immediate deployment but back-ordered by several months. As just one example, one such incident occurred in the deployment of a cluster of equipment. The storage network equipment required for the deployment was back ordered by 16 months, and thus, the topology design was re-assessed manually and changed manually to replace first equipment with alternative second equipment at the last moment causing significant delays in the deployment.

The proposed solution can play a critical role in fulfilling the “time-to-value” (TTV) service level agreement (SLA) with on-premises and/or cloud deployment customers for as-a-service offers. For example, example SaaS Offer services may have a TTV of 14 days from order to service activation that can be taken into account.

In an example embodiment, the solution can be realized as an “AI-model-as-a-service; and deployed as a “Design verification” portal in an internal/external portal (e.g., deployment console, usage console, etc.). During the end-to-end flow of the “as-a-service” deployment, the deployment team can take the design (wiring diagram with components and connections as a JSON file) and avail the services of the “Design verification” portal just prior to the equipment procurement. If the validation score is below a pre-determined threshold, ordering the equipment can be held off before committing, and the design can be returned for re-verification.

Regarding the use of GNN, a benefit lies in the realization and modeling of the deployment infrastructure as a directed acyclic graph (DAG) and the use of GNN to identify not only the technical aspects of the design but also the logistical items such as supply-chain factors to assess the robustness of the design. It is noted having a 3-layer GNN system is just an embodiment of the solution. It could very well be a 5-layer on n-layer system.

As mentioned, a graph model of a Kubernetes cluster can be made and conformance to a pre-validated system template can be determined. In another example embodiment, multiple types of templates are considered, as well as cost is a consideration, e.g., a grading on an X axis of conformance to the pre-validated templates, with cost on the Y axis, as well as different types of templates, production storage system, proof of concept (POC), development cluster, etc. having multiple templates to tackle the cost is just one example use case.

In another example embodiment, the software “as-a-service” deployment solution is being used as a scenario that can be construed as a green-field deployment. During such deployments, the customer avails the “as-a-service” Offer in the form of the total number of CPUs, total memory, storage, and required bandwidth. Thus, all the required information to design the cluster is known to the analysis tool.

For brown-field deployments, the proposed solution can be useful in identifying typical design issues such as scaling, high availability, and performance bottlenecks associated with network throughput. In addition, if the current cluster is going through a scale-out capacity expansion, a comprehensive review of the existing design when combined with the newly added nodes/equipment can be performed.

It will be appreciated by those skilled in the art that the preceding examples and embodiments are exemplary and not limiting to the scope of the present disclosure. It shall also be noted that elements of any claims may be arranged differently including having multiple dependencies, configurations, and combinations.

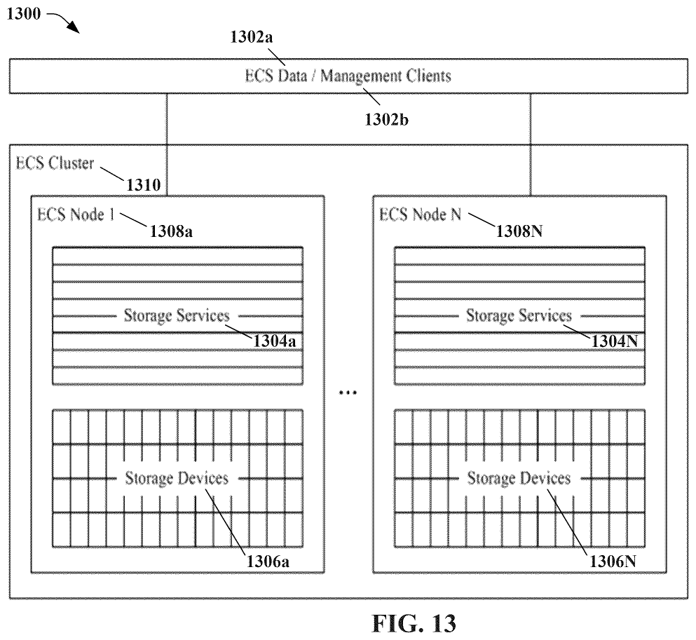

In the following, FIG. 13 describes an example non-limiting cloud storage system in the non-limiting context of an ECS storage system, but for the avoidance of doubt, the subject embodiments can apply to any storage platform. For instance, in this regard, FIG. 13 illustrates an ECS storage system 1300 comprising a cloud-based object storage appliance in which corresponding storage control software comprising, e.g., ECS data client(s) 1302a, ECS management client(s) 1302b, storage service(s) 1304a . . . 1304N, etc. and storage devices 1306a . . . 1306N (e.g., storage media, such as physical magnetic disk media, etc. of respective ECS nodes of ECS cluster 1310) are combined as an integrated system with no access to the storage media other than through the ECS storage system 1300.

In this regard, ECS cluster 1310 comprises multiple nodes 1308a . . . 1308N, storage nodes, ECS nodes, etc. Each node is associated with storage devices 1306a . . . 1306N, e.g., hard drives, physical disk drives, storage media, etc. In embodiment(s), ECS node 1308a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 1300 can be an append-only virtual storage platform that protects content from being erased or overwritten for a specified retention period. In particular, the ECS storage system 1300 does not employ traditional data protection schemes like mirroring or parity protection. Instead, the ECS storage system 1300 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 1300 can support storage, manipulation, and/or analysis of unstructured data on a massive scale on commodity hardware. As an example, the ECS storage system 1300 can support mobile, cloud, big data, and/or social networking applications. In another example, the ECS storage system 1300 can be deployed as a turnkey storage appliance, or as a software product that can be installed on a set of qualified commodity servers and disks, e.g., within a node, data storage node, etc. of a cluster, data storage cluster, etc. In this regard, the ECS storage system 1300 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1422, disk storage 1424, and/or memory storage 1446, further description of which is below. For instance, nonvolatile memory can be included in read only memory (ROM), programmable ROM (PROM), electrically programmable ROM (EPROM), electrically erasable ROM (EEPROM), or flash memory. Volatile memory 1420 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

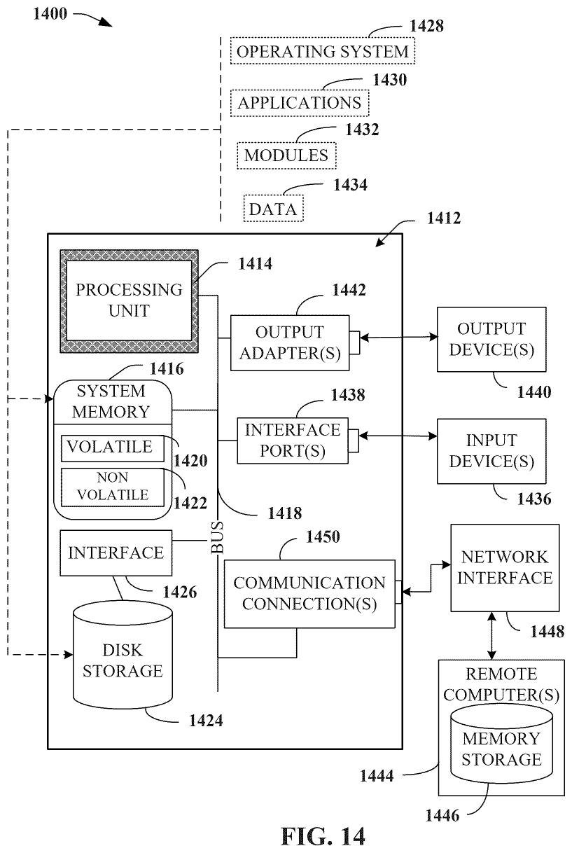

In order to provide a context for the various aspects of the disclosed subject matter, FIG. 14, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 14, a block diagram of a computing system 1400, e.g., system 140, operable to execute the disclosed systems and methods is illustrated, in accordance with an embodiment. Computer 1412 comprises a processing unit 1414, a system memory 1416, and a system bus 1418. System bus 1418 couples system components comprising, but not limited to, system memory 1416 to processing unit 1414. Processing unit 1414 can be any of various available processors. Dual microprocessors and other multiprocessor architectures also can be employed as processing unit 1414.

System bus 1418 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1416 comprises volatile memory 1420 and nonvolatile memory 1422. A basic input/output system (BIOS), containing routines to transfer information between elements within computer 1412, such as during start-up, can be stored in nonvolatile memory 1422. By way of illustration, and not limitation, nonvolatile memory 1422 can comprise ROM, PROM, EPROM, EEPROM, or flash memory. Volatile memory 1420 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1412 also comprises removable/non-removable, volatile/non-volatile computer storage media. FIG. 14 illustrates, for example, disk storage 1424. Disk storage 1424 comprises, but is not limited to, devices like a magnetic disk drive, floppy disk drive, tape drive, Jaz drive, Zip drive, LS-100 drive, flash memory card, or memory stick. In addition, disk storage 1424 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to system bus 1418, a removable or non-removable interface is typically used, such as interface 1426.

It is to be appreciated that FIG. 14 describes software that acts as an intermediary between users and computer resources described in suitable operating environment 1400. Such software comprises an operating system 1428. Operating system 1428, which can be stored on disk storage 1424, acts to control and allocate resources of computer system 1412. System applications 1430 take advantage of the management of resources by operating system 1428 through program modules 1432 and program data 1434 stored either in system memory 1416 or on disk storage 1424. It is to be appreciated that the disclosed subject matter can be implemented with various operating systems or combinations of operating systems.

A user can enter commands or information into computer 1412 through input device(s) 1436. Input devices 1436 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1414 through system bus 1418 via interface port(s) 1438. Interface port(s) 1438 comprise, for example, a serial port, a parallel port, a game port, a universal serial bus (USB), a wireless based port, e.g., Wi-Fi, Bluetooth, etc. Output device(s) 1440 use some of the same type of ports as input device(s) 1436.

Thus, for example, a USB port can be used to provide input to computer 1412 and to output information from computer 1412 to an output device 1440. Output adapter 1442 is provided to illustrate that there are some output devices 1440, like display devices, light projection devices, monitors, speakers, and printers, among other output devices 1440, which use special adapters. Output adapters 1442 comprise, by way of illustration and not limitation, video and sound devices, cards, etc. that provide means of connection between output device 1440 and system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. Remote computer(s) 1444 can be a personal computer, a server, a router, a network PC, a workstation, a microprocessor based appliance, a peer device, or other common network node and the like, and typically comprises many or all of the elements described relative to computer 1412.

For purposes of brevity, only a memory storage device 1446 is illustrated with remote computer(s) 1444. Remote computer(s) 1444 is logically connected to computer 1412 through a network interface 1448 and then physically and/or wirelessly connected via communication connection 1450. Network interface 1448 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1450 refer(s) to hardware/software employed to connect network interface 1448 to bus 1418. While communication connection 1450 is shown for illustrative clarity inside computer 1412, it can also be external to computer 1412. The hardware/software for connection to network interface 1448 can comprise, for example, internal and external technologies such as modems, comprising regular telephone grade modems, cable modems and DSL modems, wireless modems, ISDN adapters, and Ethernet cards.

The computer 1412 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1412 can connect to other devices/networks by way of antenna, port, network interface adaptor, wireless access point, modem, and/or the like.

The computer 1412 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at a 14 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
receiving a first representation of a first physical infrastructure topology wiring diagram;
transforming the first representation of the first physical infrastructure topology wiring diagram into a multi-graph comprising a group of nodes and a collection of unique edges;
based on the multi-graph, performing a first feature extraction process on the group of nodes and a second feature extraction process on the collection of unique edges; and
based on a first result of the first feature extraction process and a second result of the second feature extraction process, training a model using a n-level graph neural network, wherein n represents an integer value greater than, or equal to, 3, the training comprising training the model to be usable to evaluate a second representation of a second physical infrastructure topology wiring diagram based on the model.

2. The system of claim 1, wherein the first representation of the first physical infrastructure topology wiring diagram is received as a wiring schematic comprising a group of hardware equipment representations representative of hardware equipment and a group of wiring representations representative of interconnections between the hardware equipment in the group of hardware equipment representations.

3. The system of claim 1, wherein the first representation of the first physical infrastructure topology wiring diagram is received as an open standard data interchange file format representation of the first physical infrastructure topology wiring diagram, and wherein physical interconnections between first hardware equipment included in a group of hardware equipment and second hardware equipment included in the group of hardware equipment are represented as attribute-value pairs.

4. The system of claim 1, wherein the group of nodes is representative of firewall equipment, global traffic management equipment, local traffic management equipment, load balancing equipment, master node equipment, and worker node equipment.

5. The system of claim 1, wherein the group of nodes are representative of management resource equipment, storage resource equipment, peer-to-peer network equipment, and wherein at least the management resource equipment and the storage resource equipment enables resource sharing amongst first hardware equipment included in the group of equipment and second hardware equipment included in the group of equipment.

6. The system of claim 1, wherein a unique edge of the collection of unique edges comprises a wired interconnection between first hardware equipment included in a group of hardware equipment and second hardware equipment included in the group of hardware equipment.

7. The system of claim 1, wherein the collection of unique edges comprises a wireless interconnection between first hardware equipment included in a group of hardware equipment and second hardware equipment included in the group of hardware equipment.

8. The system of claim 1, wherein the performing of the first feature extraction process, based at least in part on the first physical infrastructure topology wiring diagram further comprises extracting a group of attribute properties associated with first hardware equipment included in a group of hardware equipment, and wherein an attribute of the group of attribute properties is a performance metric that characterizes a speed at which storage equipment is able to read and write data.

9. A method, comprising:
in response to receiving a first representation of a first physical infrastructure topology wiring diagram, transforming, by a device comprising at least one processor, the first representation of the first physical infrastructure topology wiring diagram into a multi-graph comprising a group of nodes and a collection of unique edges;
based on the multi-graph, performing, by the device, a first feature extraction process on the group of nodes to generate a first result and a second feature extraction process on the collection of unique edges to generate a second result; and
evaluating, by the device, a second representation of a second physical infrastructure topology wiring diagram based on a model that was trained based on the first result and the second result using a n-level graph neural network, wherein n represents an integer value greater than 2.

10. The method of claim 9, wherein the first representation of the first physical infrastructure topology wiring diagram is received as a wiring schematic comprising a group of hardware equipment representations representative of hardware equipment and a group of wiring representations representative of interconnections between the hardware equipment in the group of hardware equipment representations.

11. The method of claim 9, wherein the first representation of the first physical infrastructure topology wiring diagram is received as an open standard data interchange file format representation of the first physical infrastructure topology wiring diagram, and wherein physical interconnections between first hardware equipment included in a group of hardware equipment and second hardware equipment included in the group of hardware equipment are represented as attribute-value pairs.

12. The method of claim 9, wherein the group of nodes is representative of firewall equipment, global traffic management equipment, local traffic management equipment, load balancing equipment, master node equipment, and worker node equipment.

13. The method of claim 9, wherein the group of nodes are representative of management resource equipment, storage resource equipment, peer-to-peer network equipment, and wherein at least the management resource equipment and the storage resource equipment enables resource sharing amongst first hardware equipment included in the group of equipment and second hardware equipment included in the group of equipment.

14. The method of claim 9, wherein a unique edge of the collection of unique edges comprises a wired interconnection between first hardware equipment included in a group of hardware equipment and second hardware equipment included in the group of hardware equipment.

15. The method of claim 9, wherein the collection of unique edges comprises a wireless interconnection between first hardware equipment included in a group of hardware equipment and second hardware equipment included in the group of hardware equipment.

16. The method of claim 9, further comprising, based at least in part on the first physical infrastructure topology wiring diagram, extracting, by the device, a group of attribute properties associated with first hardware equipment included in a group of hardware equipment, wherein an attribute of the group of attribute properties is a performance metric that characterizes respective speeds at which storage equipment reads and writes data.

17. A non-transitory machine-readable medium, comprising executable instructions that, when executed by at least one processor, facilitate performance of operations, comprising:
receiving a first representation of a first physical infrastructure topology wiring diagram;
transforming the first representation of the first physical infrastructure topology wiring diagram into a multi-graph comprising a group of nodes and a collection of unique edges;
based on the multi-graph, performing a first feature extraction process on the group of nodes and a second feature extraction process on the collection of unique edges;
based on a first result of the first feature extraction process and a second result of the feature extraction process, generating a model using a n-level graph neural network, wherein n represents an integer value greater than, or equal to, a defined value; and
evaluating a second representation of a second physical infrastructure topology wiring diagram based on the model.

18. The non-transitory machine-readable medium of claim 17, wherein the evaluating of the second representation of the second physical infrastructure topology wiring diagram comprises:
generating a real number score value based on the model;
comparing the real number score value with a threshold value; and
determining, based on the real number score value exceeding the threshold value, that the second representation of the second physical infrastructure topology wiring diagram is a good design.

19. The non-transitory machine-readable medium of claim 17, wherein the evaluating of the second representation of the second physical infrastructure topology wiring diagram comprises:
generating a real number score value based on the model;
comparing the real number score value with a threshold value; and
determining, based on the real number score value falling below the threshold value, that the second representation of the second physical infrastructure topology wiring diagram is a poor design.

20. The non-transitory machine-readable medium of claim 19, wherein the operations further comprise based on the real number score value, regenerating the model using the n-level graph neural network.
